(19) United States
(12) Patent Application Publication
(10) Pub. No.: US 2021/0158373 A1
(43) Pub. Date: May 27, 2021

(54) AUTOMATED SOFTWARE LICENSE RECLAMATION

(71) Applicant: ServiceNow, Inc., Santa Clara, CA (US)

(72) Inventors: Manish Srivastava, Cary, NC (US); German Bertot, San Carlos, CA (US); Colby Blakeman, San Diego, CA (US); Brian Hudson, San Jose, CA (US)

(21) Appl. No.: 17/071,690

(22) Filed: Oct. 15, 2020

Related U.S. Application Data
(63) Continuation of application No. 15/587,261, filed on May 4, 2017, now abandoned.

(51) Int. Cl. G06Q 30/00; G06F 21/10; G06F 8/61; G06Q 10/10; G06Q 50/18; G06Q 30/06; G06Q 20/12; H04L 12/24

(52) U.S. Cl. CPC G06Q 30/0185; G06F 21/105; G06F 8/62; G06Q 10/10; G06Q 50/182; G06Q 2220/18; G06Q 20/1235; H04L 41/22; G06F 2221/0773; G06Q 2220/123; G06Q 30/0633

(57) ABSTRACT

A system may include one or more server devices disposed within a remote network management platform. The server devices may communicate with computing devices that are disposed within a managed network. The server devices may store a representation of software programs determined as installed on each of the computing devices. The server devices may also determine, by comparing software license rights to the representation of the software programs determined to be installed on each of the computing devices, whether the managed network is in compliance with the software program license rights. The devices may additionally provide, to a client device that is disposed within the managed network, a representation of a graphical user interface that denotes whether the managed network is in compliance with the software program license rights. The graphical user interface may include a reclamation rules page.

### BACKGROUND

An enterprise may use thousands of individual computing devices to efficiently facilitate and manage its many interrelated operations. Each such computing device may require a unique combination of software programs to perform operations particular to that computing device. Where the software is proprietary, the enterprise may procure licenses for the computing devices to use the software.

### SUMMARY

The embodiments herein involve, but are not limited to, ways in which an enterprise may track usage of software programs, and to what degree such usage complies with licenses associated with the software programs. A computing device associated with the enterprise may interact with a software management tool via a graphical user interface (GUI) to determine such usage and compliance. In particular, the embodiments described hereafter may automatically determine how many software programs are installed by computing devices associated with the enterprise, compare the installed software programs to software licenses, and, for these programs, provide indications of the degree to which the installed software programs comply with the software licenses.

Accordingly, a first example embodiment may involve a system that may include a proxy server application operable on a proxy server device that is disposed within a managed network. The system may further include one or more databases disposed within a remote network management platform. The one or more databases may contain representations of software program licenses held by the managed network, and the remote network management platform may manage the managed network. The system may also include one or more server devices that are disposed within the remote network management platform. The one or more server devices may be configured to communicate, by way of the proxy server application, with computing devices that are disposed within the managed network. The communication may cause the proxy server application to probe the computing devices to determine software programs installed thereon. The one or more server devices may be further configured to store, in the one or more databases, a representation of the software programs determined as installed on each of the computing devices. The one or more server devices may also be configured to determine, by comparing the software program licenses to the representation of the software programs determined as installed on each of the computing devices, whether the managed network is in compliance with the software program licenses. The one or more server devices may be additionally configured to provide, to a client device that is disposed within the managed network, a representation of a GUI that denotes whether the managed network is in compliance with the software program licenses. Reception of the representation of the GUI may cause the client device to render the GUI on a display unit of the client device. The GUI may include a display page selection pane and a reclamation rules page selectable from the display page selection pane. The reclamation rules page may include one or more data entry fields. The data entry fields may indicate a particular software program, a time period over which use of the particular software program is to be considered, and a usage reclamation threshold.

A second example embodiment may include communicating, by one or more server devices that are disposed within a remote network management platform, with computing devices that are disposed within a managed network. The remote network management platform may manage the managed network, the communication may occur by way of a proxy server application operating on a proxy server device that is disposed within the managed network, and the communication may cause the proxy server application to probe the computing devices to determine software programs installed thereon. The second example embodiment may further include storing, by the one or more server devices, a representation of the software programs determined as installed on each of the computing devices. The representation may be stored in one or more databases disposed within the remote network management platform, and the one or more databases may contain representations of software program licenses held by the managed network. The second example embodiment may also include determining, by the one or more server devices, whether the managed network is in compliance with the software program licenses by comparing the software program licenses to the representation of the software programs determined as installed on each of the computing devices. The second example embodiment may additionally include providing, by the one or more server devices and to a client device that is disposed within the managed network, a representation of a GUI that denotes whether the managed network is in compliance with the software program licenses. The reception of the representation of the GUI may cause the client device to render the GUI on a display unit of the client device. The GUI may include a display page selection pane and a reclamation rules page selectable from the display page selection pane. The reclamation rules page may include one or more data entry fields. The data entry fields may indicate a particular software program, a time period over which use of the particular software program is to be considered, and a usage reclamation threshold.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is another flow chart, in accordance with example embodiments.

FIG. 6A depicts another communication environment involving a remote network management architecture, in accordance with example embodiments.

FIG. 6B is another flow chart, in accordance with example embodiments.

FIG. 7A depicts a software discovery model page of a graphical user interface, in accordance with example embodiments.

FIG. 7B depicts another software discovery model page of a graphical user interface, in accordance with example embodiments.

FIG. 7C depicts another software discovery model page of a graphical user interface, in accordance with example embodiments.

FIG. 7D depicts another software discovery model page of a graphical user interface, in accordance with example embodiments.

FIG. 8A depicts a software entitlement page of a graphical user interface, in accordance with example embodiments.

FIG. 8B depicts another software entitlement page of a graphical user interface, in accordance with example embodiments.

FIG. 9 depicts a software model page of a graphical user interface, in accordance with example embodiments.

FIG. 10 depicts a reconciliation result page of a graphical user interface, in accordance with example embodiments.

FIG. 11 depicts a software model result page of a graphical user interface, in accordance with example embodiments.

FIG. 12 depicts a reclamation rules page of a graphical user interface, in accordance with example embodiments.

FIG. 13 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its business, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data is stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

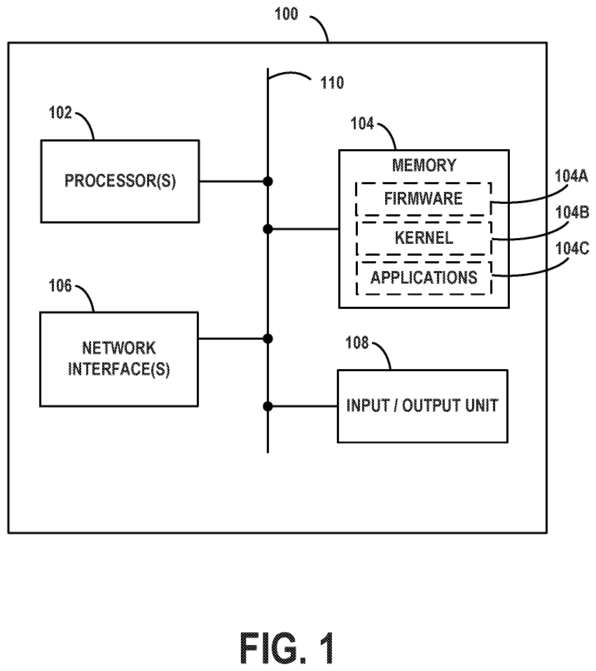

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations.

In this example, computing device 100 includes processor(s) 102 (referred to as “processor 102” for sake of simplicity), memory 104, network interface(s) 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be any type of computer processing unit, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be a single-core processor, and in other cases, processor 102 may be a multi-core processor with multiple independent processing units. Processor 102 may also include register memory for temporarily storing instructions being executed and related data, as well as cache memory for temporarily storing recently-used instructions and data.

Memory 104 may be any form of computer-usable memory, including but not limited to register memory and cache memory (which may be incorporated into processor 102), as well as random access memory (RAM), read-only memory (ROM), and non-volatile memory (e.g., flash memory, hard disk drives, solid state drives, compact discs (CDs), digital video discs (DVDs), and/or tape storage). Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs.

Network interface(s) 106 may take the form of a wireline interface, such as Ethernet (e.g., Fast Ethernet, Gigabit Ethernet, and so on). Network interface(s) 106 may also support communication over non-Ethernet media, such as coaxial cables or power lines, or over wide-area media, such as Synchronous Optical Networking (SONET) or digital subscriber line (DSL) technologies. Network interface(s) 106 may also take the form of a wireless interface, such as IEEE 802.11 (Wifi), BLUETOOTH®, global positioning system (GPS), or a wide-area wireless interface. However, other forms of physical layer interfaces and other types of standard or proprietary communication protocols may be used over network interface(s) 106. Furthermore, network interface(s) 106 may comprise multiple physical interfaces. For instance, some embodiments of computing device 100 may include Ethernet, BLUETOOTH®, and Wifi interfaces.

Input/output unit 108 may facilitate user and peripheral device interaction with example computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more instances of computing device 100 may be deployed to support an aPaaS architecture. The exact physical location, connectivity, and configuration of these computing devices may be unknown and/or unimportant to client devices.

Accordingly, the computing devices may be referred to as “cloud-based” devices that may be housed at various remote data center locations.

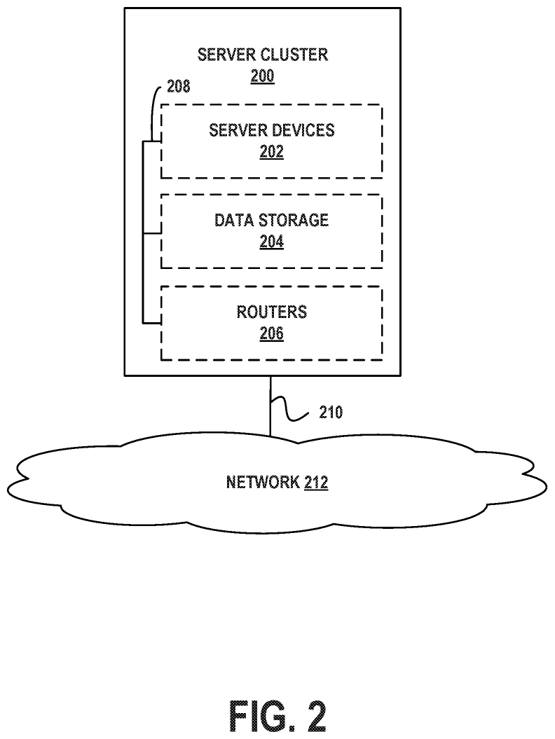

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of cluster data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via cluster network 208, and/or (ii) network communications between the server cluster 200 and other devices via communication link 210 to network 212.

Additionally, the configuration of cluster routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tupl es. Furthermore, any databases in data storage 204 may be monolithic or distributed across multiple physical devices.

Server devices 202 may be configured to transmit data to and receive data from cluster data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### III. EXAMPLE REMOTE NETWORK MANAGEMENT ARCHITECTURE

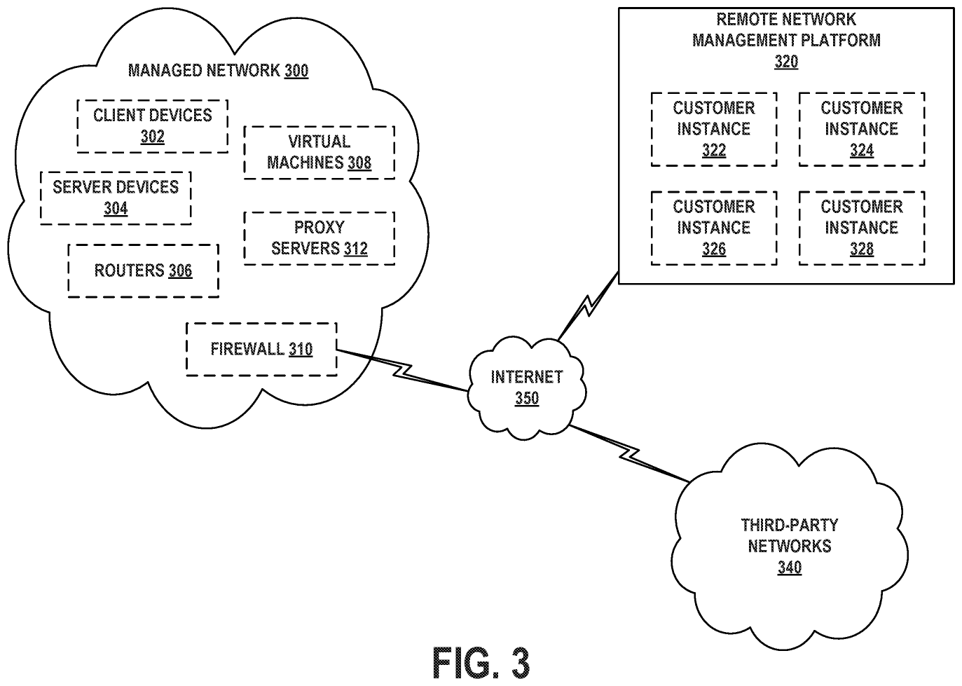

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by a business for computing and communications tasks, as well as storage of data. Thus, managed network 300 may include various client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices and services therein, while allowing authorized communication that is initiated from managed network 300. Firewall 310 may also provide intrusion detection, web filtering, virus scanning, application-layer gateways, and other services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more customer instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four customer instances 322, 324, 326, and 328. Each of these instances may represent a set of web portals, services, and applications (e.g., a wholly-functioning aPaaS system) available to a particular customer. In some cases, a single customer may use multiple customer instances. For example, managed network 300 may be an enterprise customer of remote network management platform 320, and may use customer instances 322, 324, and 326. The reason for providing multiple instances to one customer is that the customer may wish to independently develop, test, and deploy its applications and services. Thus, customer instance 322 may be dedicated to application development related to managed network 300, customer instance 324 may be dedicated to testing these applications, and customer instance 326 may be dedicated to the live operation of tested applications and services.

The multi-instance architecture of remote network management platform 320 is in contrast to conventional multi-tenant architectures, over which multi-instance architectures have several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database

In contrast, the multi-instance architecture provides each customer with its own database in a dedicated computing instance. This prevents comingling of customer data, and allows each instance to be independently managed. For example, when one customer's instance experiences an outage due to errors or an upgrade, other customer instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In order to support multiple customer instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, customer instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® Azure. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

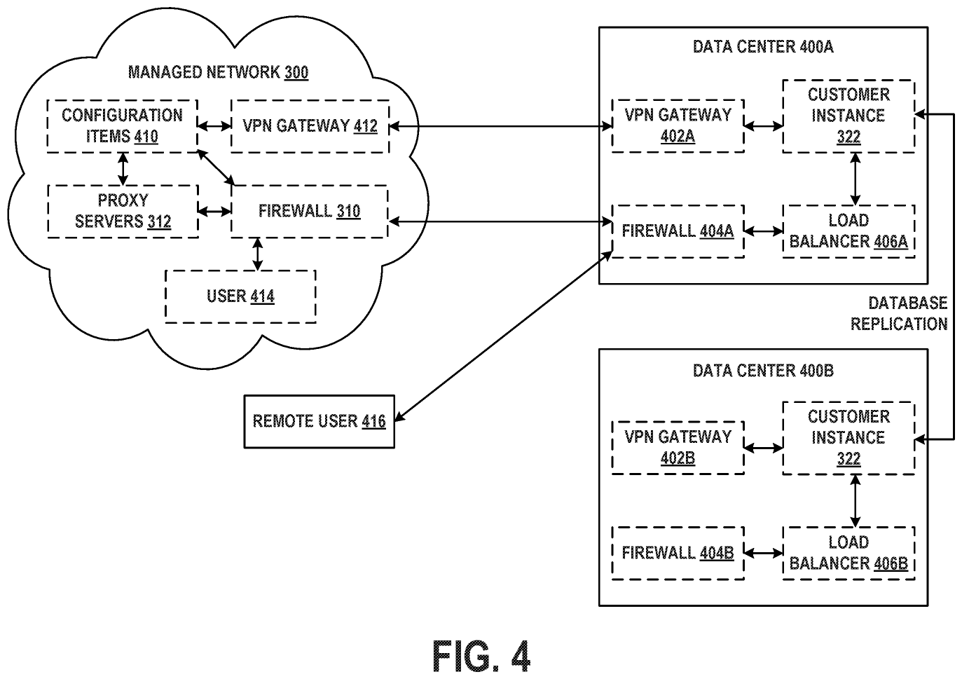

FIG. 4 further illustrates the communication environment between managed network 300 and customer instance 322, and introduces additional features and alternative embodiments. In FIG. 4, customer instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC). Firewall 404A may be configured to allow access from authorized users, such as user 414 and remote user 416, and to deny access to unauthorized users. By way of firewall 404A, these users may access customer instance 322, and possibly other customer instances. Load balancer 406A may be used to distribute traffic amongst one or more physical or virtual server devices that host customer instance 322. Load balancer 406A may simplify user access by hiding the internal configuration of data center 400A, (e.g., customer instance 322) from client devices. For instance, if customer instance 322 includes multiple physical or virtual computing devices that share access to multiple databases, load balancer 406A may distribute network traffic and processing tasks across these computing devices and databases so that no one computing device or database is significantly busier than the others. In some embodiments, customer instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, customer instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of customer instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of customer instance 322 with one or more Internet Protocol (IP) addresses of data center 400A may re-associate the domain name with one or more IP addresses of data center 400B. After this re-association completes (which may take less than one second or several seconds), users may access customer instance 322 by way of data center 400B.

FIG. 4 also illustrates a possible configuration of managed network 300. As noted above, proxy servers 312 and user 414 may access customer instance 322 through firewall 310. Proxy servers 312 may also access configuration items 410. In FIG. 4, configuration items 410 may refer to any or all of client devices 302, server devices 304, routers 306, and virtual machines 308, any applications, programs, or services executing thereon, as well as relationships between devices and services. Thus, the term “configuration items” may be shorthand for any physical or virtual device or service remotely discoverable or managed by customer instance 322, or relationships between discovered devices and services. Configuration items may be represented in a configuration management database (CMDB) of customer instance 322.

As noted above, VPN gateway 412 may provide a dedicated VPN to VPN gateway 402A. Such a VPN may be helpful when there is a significant amount of traffic between managed network 300 and customer instance 322, or security policies otherwise suggest or require use of a VPN between these sites. In some embodiments, any device in managed network 300 and/or customer instance 322 that directly communicates via the VPN is assigned a public IP address. Other devices in managed network 300 and/or customer instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE AND SERVICE DISCOVERY

In order for remote network management platform 320 to administer the devices and services of managed network 300, remote network management platform 320 may first determine what devices are present in managed network 300, the configurations and operational statuses of these devices, and the services provided by the devices, and well as the relationships between discovered devices and services. As noted above, each device, service, and relationship may be referred to as a configuration item. The process of defining configuration items within managed network 300 is referred to as discovery, and may be facilitated at least in part by proxy servers 312.

For purpose of the embodiments herein, a “service” may refer to a process, thread, application, program, server, or any other software that executes on a device. A “service” may also refer to a high-level capability provided by multiple processes, threads, applications, programs, and/or servers on one or more devices working in conjunction with one another. For example, a high-level web service may involve multiple web application server threads executing on one device and accessing information from a database service that executes on another device. The distinction between different types or levels of services may depend upon the context in which they are presented.

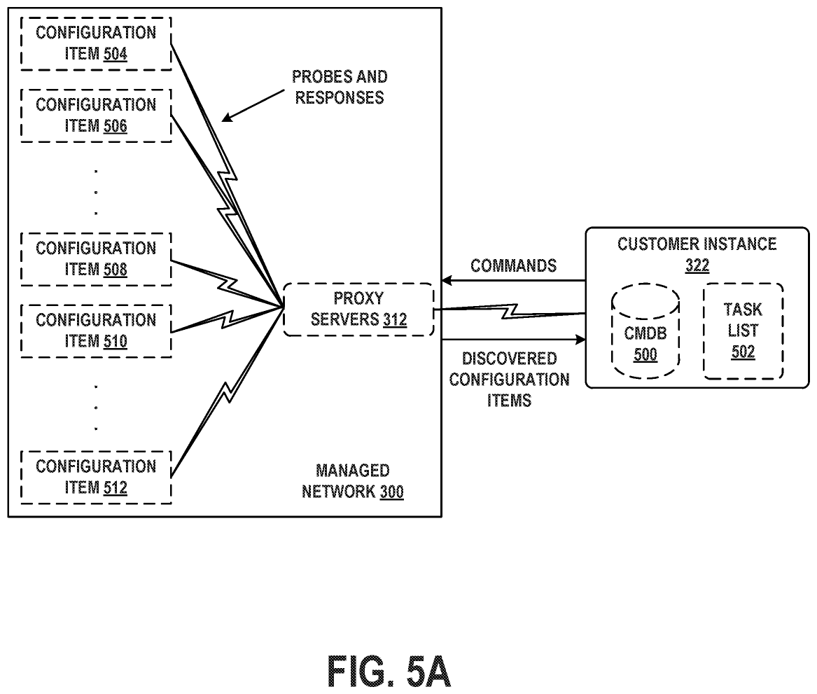

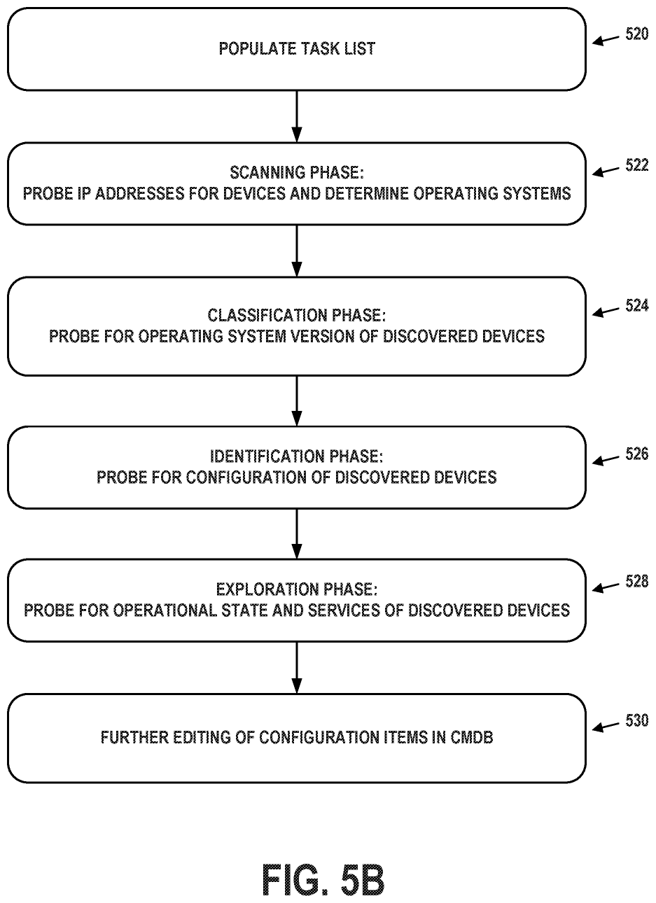

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within customer instance 322. Customer instance 322 may transmit discovery commands to proxy servers 312. In response, proxy servers 312 may transmit probes to various devices and services in managed network 300. These devices and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of customer instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, customer instance 322 may store this information in CMDB 500 and place tasks in task list 502 for discovery of devices at each of these addresses.

FIG. 5A also depicts devices and services in managed network 300 as configuration items 504, 506, 508, 510, and 512. As noted above, these configuration items represent a set of physical and/or virtual devices (e.g., client devices, server devices, routers, or virtual machines), services executing thereon (e.g., web servers, email servers, databases, or storage arrays), relationships therebetween, as well as higher-level services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, as a set of LINUX®-specific probes may be used. Likewise if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (services), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device and service is available in CMDB 500. For example, after discovery, operating system version, hardware configuration and network configuration details for client devices, server devices, and routers in managed network 300, as well as services executing thereon, may be stored. This collected information may be presented to a user in various ways to allow the user to view the hardware composition and operational status of devices, as well as the characteristics of services.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the customer instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and services executing on the discovered devices. At block 530, further editing of the configuration items representing the discovered devices and services may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. EXAMPLE NORMALIZATION OF CONFIGURATION ITEMS

During each phase of discovery, various modules of customer instance 322 may process the responses to the probes sent from proxy servers 312. Such processing may assist in identifying various characteristics of the configuration items represented by the responses. After processing the responses, the modules may update each configuration item stored in the CMDB 500 such that each configuration item more accurately represents a device, service, or relationship that is present in the managed network. Such processing and updating of configuration items may be referred to as normalization.

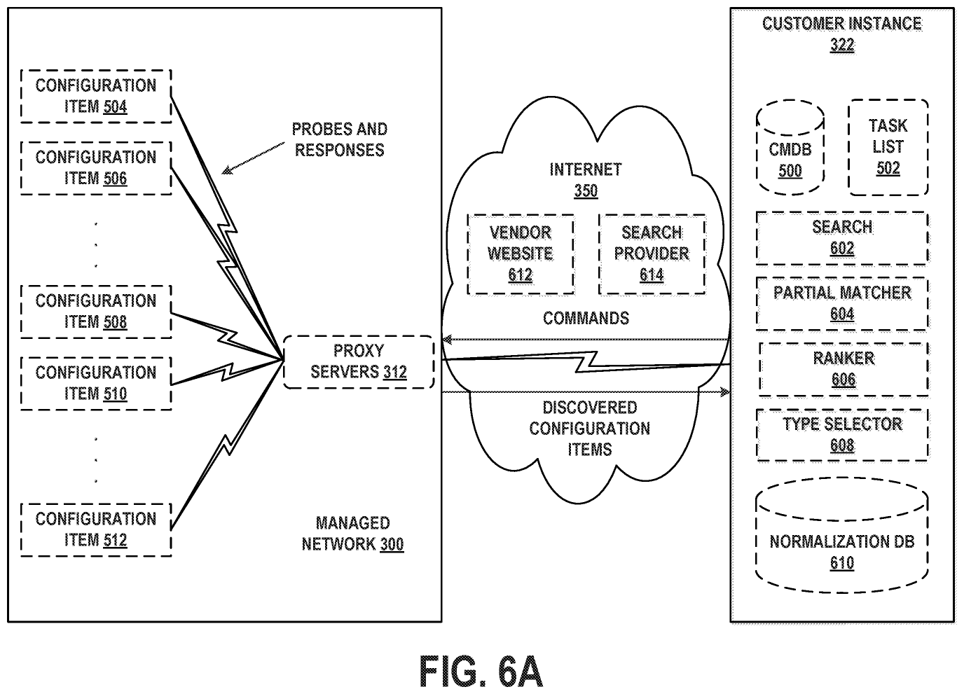

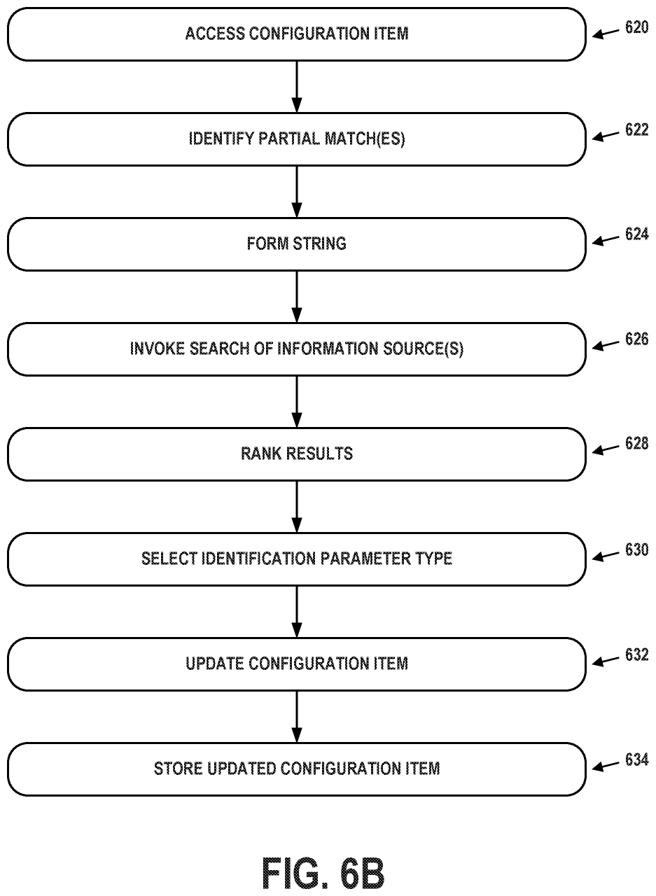

FIG. 6A provides a logical depiction of how configuration items can be normalized, as well as how normalized information related to discovered configuration items can be stored. For sake of simplicity, remote network management platform 320 and third-party networks 340 are not depicted. Though FIG. 6A includes additional details not included in FIG. 5A, it should be understood that the discovery process described above may be performed in conjunction with the additional features described with regard to FIG. 6A.

In FIG. 6A, CMDB 500, task list 502, search module 602, partial matcher module 604, ranker module 606, type selector module 608, and normalization database 610 are stored within customer instance 322. Customer instance 322 may include one or more server devices that transmit, via Internet 350, discovery commands to a proxy server application associated with proxy servers 312. In response, proxy servers 312 may transmit probes to various computing devices disposed within managed network 300. These devices may transmit responses to proxy servers 312, and proxy servers 312 may then provide information regarding discovered configuration items to CMDB 500 for storage therein. Search module 602, partial matcher module 604, ranker module 606, type selector module 608, and normalized service type database 610 may process the information provided by proxy servers 312. Once the information provided by proxy servers 312 has been normalized, the configuration items stored in CMDB 500 may be updated. Consequently, the updated configuration items stored in CMDB 500 may more accurately represent the environment of managed network 300.

Customer instance 322 may compare information received from proxy servers 312 to data stored in the normalization database 610 to determine whether a configuration item is correctly identified. Each configuration item may have several identification parameters. For example, a computing device may be represented by identification parameters that include a model, type, and operating system of the computing device. As another example, a software program may be represented by identification parameters that include a publisher, product, edition, version, and a product description of the software program. Normalization database 610 may store data representative of identification parameters associated with known devices, services, or relationships that may exist within a managed network.

Though normalization database 610 is depicted as being disposed within customer instance 322, normalization database 610 may receive additional normalization data from a normalization database that communicates with other customer instances, such as customer instances 324, 326, and 328. In other embodiments, normalization database 610 might not be disposed with a particular customer instance at all, and may store data representative of several managed networks, or even a comprehensive set of every known device, service, or relationship of any managed network associated with remote network management platform 320. In such embodiments, one or more server devices disposed within customer instance 322 may communicate with normalization database 610 to normalize the configuration items.

When comparing the information received from proxy servers 312 to the data stored in normalization database 610, customer instance 322 may determine that the identification parameters received from the proxy servers 312 are incomplete, or that they do not match identification parameters stored on the normalization database 610. In this case, customer instance 322 may invoke search 602, partial matcher 604, ranker 606, and type selector 608 modules to determine appropriate identification parameters to associate with the configuration item. Further, responsive to determining the appropriate identification parameters, customer instance 322 may update the configuration items stored in CMDB 500.

Search module 602 may be configured to search external information sources, such as vendor website 612 owned by a software publisher (e.g. MICROSOFT®), or search provider 614 (e.g., GOOGLE® search or BING® search). Such searches may include as key words portions of the information received from proxy servers 312. For example, received information representative of a particular configuration item may include an incomplete or unrecognized identification parameter, such as a publisher name. In response, search module 602 may search external information sources to determine the publisher name. Though only vendor website 612 and search provider 614 are displayed in FIG. 6A, it should be understood that other information sources, such as a vendor Application Programming Interface (API), may be used to determine incomplete information.

Search results from search module 604 may be passed to ranker module 604, which may apply a score to each search result and rank the results based on the applied score.

The ranked search results may be passed to the type selector module 608, which selects a type of device, service, or relationship from the normalization database. To select an appropriate type of device, service, or relationship from normalization database 610, type selector module 608 may invoke partial matcher module 604. Partial matcher module 604 may determine the known identification parameters stored within normalization database 610 that match a highly ranked search result from ranker module 606.

Once a known identification parameter has been selected by the type selector module 608, the configuration item associated with the initially incomplete or unrecognized identification parameter may be updated within CMDB 500.

In other examples, search 602, partial matcher 604, ranker 606, and type selector 608 modules may be unable to determine a known identification parameter stored in normalization database 610 that appropriately corresponds to the configuration item associated with the initially incomplete or unrecognized identification parameter. In such examples, a GUI may prompt a user for manual entry of normalized identification parameters associated with the configuration item. In these examples, normalization database 610 may store the newly added normalization data input into data entry fields of the graphical user interface, for use when normalizing other configuration items.

In an example scenario, customer instance 322 may receive information from proxy servers 312 that is representative of configuration item 506 and store the information in CMDB 500. Configuration item 506 may be associated with a software program installed on a computing device within managed network 300. The information may include several identification parameters, including the following: publisher: “Publisher X”, product: “Product B”, edition: “”, version: “Version D”, OS: “Operating System Z”, product description: “Publisher A Product B Edition C Version D”. In this example scenario, “Publisher X” may be a misspelling of “Publisher A”. Further, edition is missing entirely in the example scenario. Such errors may occur, for example, due to manual entry of the identification parameters.

In the example scenario, customer instance 322 may perform the steps displayed in the flow chart of FIG. 6B to normalize configuration item 506. First, customer instance 322 may perform block 620 to access configuration item 506. In the example scenario, customer instance 322 accesses configuration item 506 by way of CMDB 500. However, in other examples, accessing the configuration item may be performed contemporaneously with receiving the information from proxy servers 312.

Second, customer instance 322 may perform block 622 to identify partial matches between the accessed configuration item and data stored in normalization database 610. In the example scenario, customer instance may compare known identification parameters stored in the normalization database 610 to the information representative of configuration item 506. These sets of data may take the form of a plurality of strings. For example, customer instance may compare the misspelled publisher “Publisher X” to known identification parameters that correspond to publishers, such as “Publisher A”, “Publisher B”, and “Publisher C” stored in normalization database 610.

In this example scenario, normalization database 610 might not have stored therein an identification parameter that matches incorrectly spelled “Publisher X”. However, it should be understood that normalization database 610 may update include common misspellings of various software publishers, products, versions, editions, or the like. As such, in some scenarios, normalization database 610 can recognize the error in spelling without invoking the search 602, partial matcher 604, ranker 606, and type selector 608 modules. Further, it should be understood that customer instance 322 may be configured to determine the misspelled identification parameter based on additional identification parameters associated with the configuration item. For example, normalization database 610 may recognize that the publisher should be spelled “Publisher A” rather than “Publisher X” based on the product description “Publisher A Product B Edition C Version D”, and customer instance 322 may affiliate this identification parameter with a publisher spelled “Publisher A”. Customer instance 322, may determine additional identification parameters based on the product description parameter. For instance, in the present example, the missing edition parameter may be determined to be “Edition C” based on the product description parameter.

In the example scenario, the customer instance 322 may next perform block 624. Particularly, customer instance 322 may form a string based on the partial matches to determine the publisher and version number associated with configuration item 506. The string, for example, may simply include unrecognized term “Publisher X”. However, it should be understood that other portions of data associated with configuration item 506 may be used to form the string, such as a portion of the product description parameter.

Customer instance 322 may use the string formed based on the partial matches to perform block 626. In the example scenario, search module 602 may use the formed string “Publisher X” as a search query for use in search provider 614. Search module 602 may also scrape data from vendor website 612 to determine a close match between data in the vendor website 612 and the formed string. For example, search module 602 may scrape data from the publisher's official website using, for example, a crawler that parses data in the official website or automatically uses search functions provided by the official site to search for the formed string. Ranker module 606 may then perform block 628 to rank results determined by the search module 602. For example, the search results may be ranked based on a correlation between each search result and the search query. In the example scenario, the highest ranked result might not be “Publisher A”. For purposes of the present example scenario, it is assumed that the highest ranked result is “Publisher A”.

In the example scenario, customer instance 322 may next perform block 630 to select an identification parameter type based on the rank results of executed block 628. In some scenarios, no result will be determined to correspond to an identification parameter stored within normalization database 610. In this scenario, “Publisher A” may be compared to data in normalization database 610. Since “Publisher A” is a recognized identification parameter associated with a publisher, type selector module 608 may select this identification parameter from normalization database 610, may execute block 632 to update the identification parameter to reflect correct publisher “Publisher A”, and may execute block 634 to store an updated identification parameter for the configuration item in CMDB 500.

Though in some examples, each of the identification parameters may ultimately be normalized, in other scenarios, some of the identification parameters may remain unidentified.

The blocks represented in FIG. 6B are for purpose of example. Normalization may be a highly configurable procedure that can include more or fewer steps, and the operations of each step may vary. In some cases, one or more steps may be customized, or may otherwise deviate from the example descriptions above.

### VI. EXAMPLE SOFTWARE PROGRAM MANAGEMENT SYSTEM

An enterprise may use the computing devices described above in relation to FIGS. 1 and 2 to facilitate and manage its many interrelated operations. In turn, the computing devices may rely on software programs to perform tasks. Each computing device may be tasked with performing a set of operations, and accordingly may use a combination of software programs to perform those tasks. While some such software programs may be hosted by an aPaaS system, as described above in relation to FIGS. 1 through 4, or a Software as a Service (SaaS) system, others may be installed on the individual computing devices themselves. Such software is often proprietary, and may be licensed in several ways. For example, a software license may specify a number of computing devices that are permitted to use the software. In other examples, computing devices may include multi-core processors, and the software license may specify a number of processor cores having permission to use the software. In still other examples, the software license may identify particular computing devices or users that are permitted to use the software. Other licensing schemes are possible as well.

Regardless of the licensing scheme, the enterprise may attempt to keep track of which of its computing devices use what licensed software. In so doing, the enterprise may determine whether it is in compliance with its various software licenses, whether it is using its licensed software efficiently, and whether it should purchase new software licenses.

Tracking software program usage across an entire enterprise may present challenges. A large enterprise may use thousands of separate computing devices, each of which may use a set of software programs. Further, such computing devices may go in and out of service, or require different software programs over time. Still further, different versions or builds of each software program may be installed across these computing devices.

Tracking the use of software within an enterprise may be achieved using an aPaaS system as described above in relation to FIGS. 1 through 5B, and more particularly in relation to FIGS. 6A and 6B. Such an aPaaS system may be particularly suited to tracking such software usage because the aPaaS system may gather information from computing devices in managed networks such as the enterprise.

Tracking the use of software within an enterprise may involve determining configuration items in the manner described above in relation to FIGS. 5A through 6B. For instance, the aPaaS system may determine which software programs that are installed on computing devices within managed network 300 in a similar fashion to the example scenario described above with regard to FIGS. 6A and 6B.

To accurately track such software usage, the aPaaS system may determine which computing devices utilize what software programs. For example, during identification phase 526 of discovery, customer instance 322 may determine the configuration of discovered devices, including identification parameters indicative of specific computing devices. Further, during exploration phase 528, customer instance 322 may determine services such as software programs of each discovered device. The identification parameters associated with such software programs may indicate on which specific computing device(s) each software program is installed. However, the identification parameters may alternatively, or in addition, specify a number of processors or cores of a computing device, a device name, or a named user, associated with each software program. The identification parameters associated with the software programs may further indicate how often each software program is used by each device, processor, core, or user, as the case may be.

The aPaaS system may determine to what extent the enterprise is in compliance with its software licenses. Determining such compliance may be referred to as “reconciliation.” For example, the system may run discovery on computing devices within managed network 300 to determine how many times each software program has been installed. In other examples, the aPaaS system may rely on past discovery to determine how many instances of the software program have been installed. For example, the configuration items stored on CMDB 500 may be sufficient to determine how many instances are installed within managed network 300. The aPaaS system may also determine what software program license rights are held by the managed network. Finally, the aPaaS system may associate the installed software programs with the software license rights. Such reconciliation of the software programs may be based on a license metric associated with a specified software license. As noted above, the license metric may specify that installations are counted per computing device, per processor, per processor core, or per user, or may specify one or more named devices or users for installation counts.

When determining a number of installations under a per computing device license metric, the aPaaS system may count each computing device within the managed network having a particular software program type installed thereon, even where such software programs are installed using more than one processor or processor core on certain of the computing devices. For instance, a computing device may have two processors contained therein, and each processor may include four cores. If each core of each processor was used to install the particular software program type, totaling eight installations of the program, only one installation would be counted when using the per device license metric.

When determining a number of installations under a per processor license metric, the aPaaS system may count each processor within the managed network used to install the software program. For example, where a computing device includes two processors, and both processors are used to install the software program, both processors would be counted when using the per processor license metric. However, if each processor included four cores, and each core had the program type installed thereon, the installation count would still equal two under the per processor license metric.

When determining a number of installations under a per core license metric, the aPaaS system may count each core within each device that has the particular software program type installed thereon. For example, a computing device having two processors, each processor having four course, and each course having the particular software program type stored thereon, would count as having eight installations under the per core license metric.

When determining a number of installations under a per user license metric, the aPaaS system may determine users within the managed network that are interfaced with the particular software program type at a given time. For instance, a user may log in to a particular computing device and open the software program type while logged in to the computing device. Such a user may be counted under the per user license metric.

When determining a number of installations under a per named device license metric, the aPaaS system may determine a list of named computing devices being allocated a software program installation. The aPaaS system may determine which of the named devices on the list have the software program installed thereon, and determine whether additional computing devices within the managed network have the software program installed thereon.

When determining a number of installations under a per named user license metric, the aPaaS system may determine which of the named users on the list are interfaced with the software program at a given time, and determine whether additional users within the managed network are interfaced with the software program at a given time.

The aPaaS system may perform an action based on the extent to which the enterprise is in compliance with its software licenses. For example, the system may provide, via a GUI, a recommendation for a user to purchase additional licenses, to install a software program on more devices, or to uninstall the software program from certain computing devices within the managed network. In some examples, the aPaaS system, upon determination that certain criteria have been met, may automatically purchase additional software, or reorganize which devices, users, or cores upon which the software programs are installed.

### VII. EXAMPLE GRAPHICAL USER INTERFACES

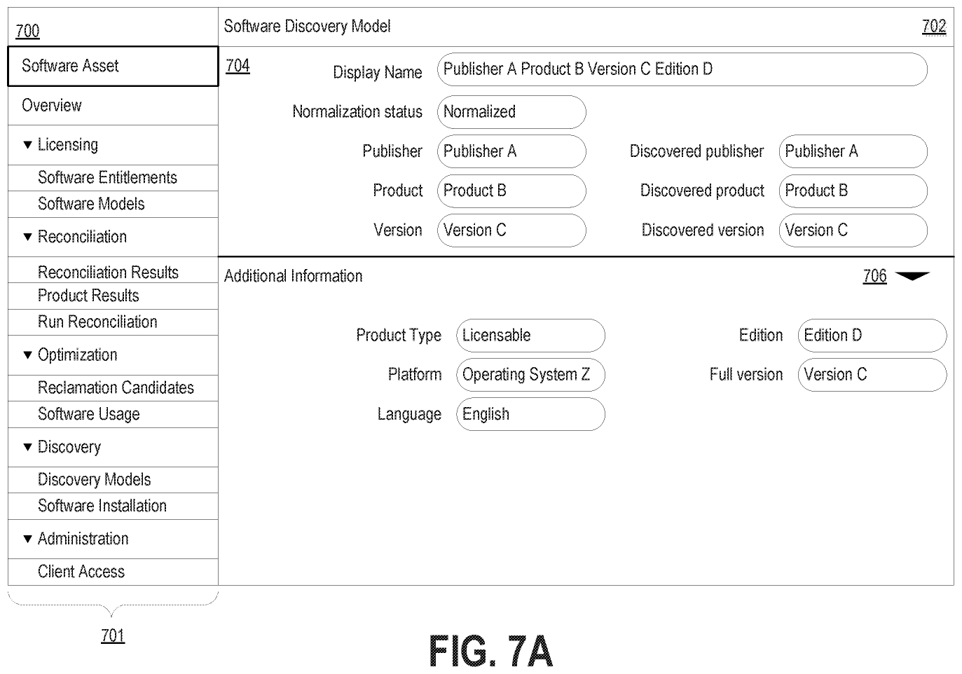

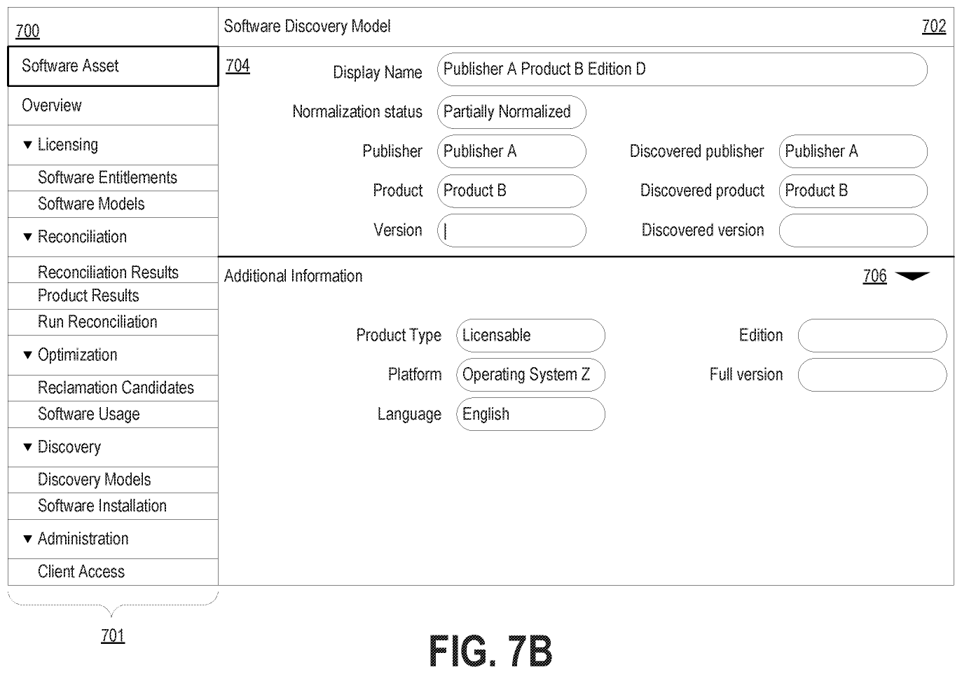

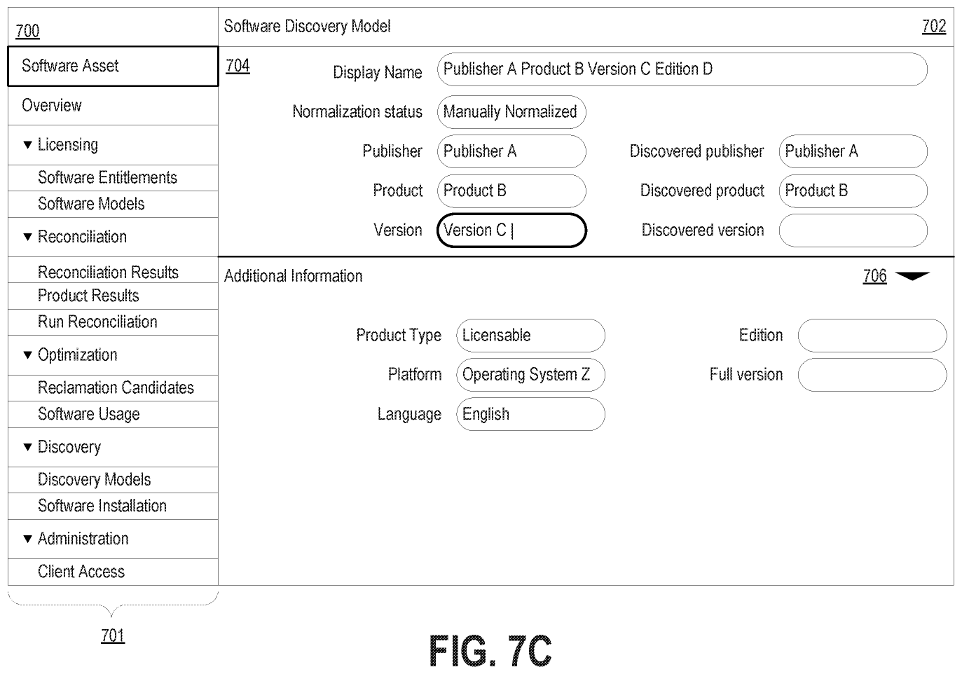

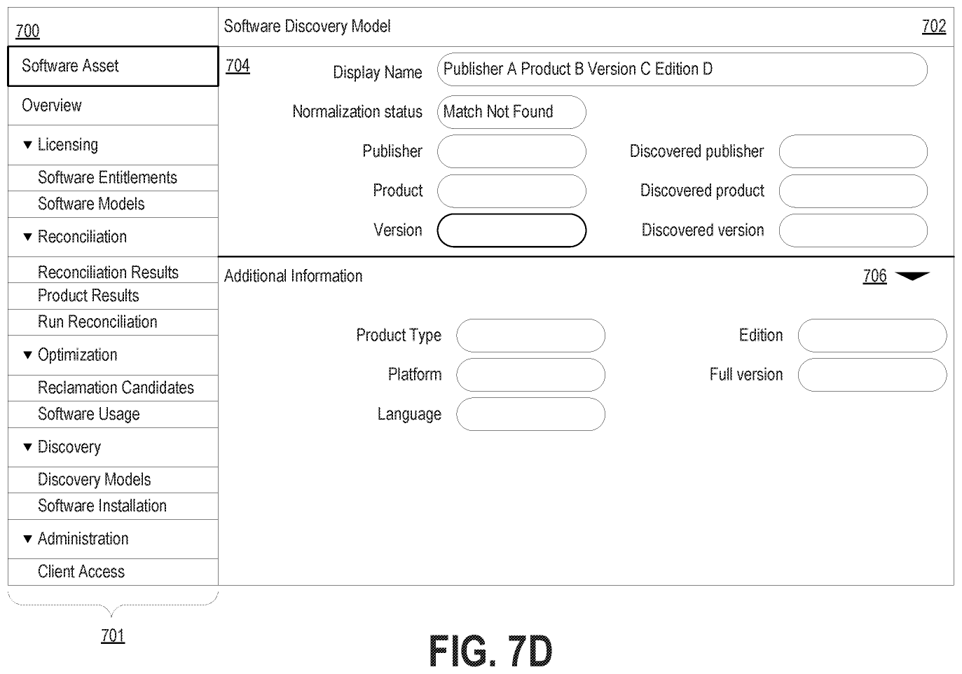

FIGS. 7A-12 depict GUIs, in accordance with example embodiments. Each of these GUIs may be provided for display on a computing device (e.g. a client device within managed network 300). The information provided therein may be derived from one or more databases associated with managed network 300 and/or one or more databases associated with remote network management platform 320. However, these GUIs are merely for purposes of illustration. The applications described herein may provide GUIs that format information differently, include more or less information, include different types of information, and relate to one another in different ways.

FIG. 7A depicts an example GUI 700 that displays a normalized configuration item associated with a particular software program type. A software program type may be a software program as specified by one or more of a publisher name, product name, version, or edition. Once discovery of a particular software program type has been completed, GUI 700 may provide selection pane 701 and a software discovery model page 702 that is selectable from selection pane 701, and that includes an identification pane 704 representative of the software program type and additional information pane 706 representative of additional information of the software program type. Software discovery model page 702 displays representations of the software program type, including a publisher name “Publisher A”, a product name “Product B”, and a version, “Version C”, each of which is represented on identification pane 704. Identification pane 704 additionally includes indications of the discovered publisher “Publisher A”, discovered product “Product B” and discovered version “Version C”. Providing such information may allow for manual correction of the normalized data if, for example, the normalization failed to identify the correct publisher, product, or version.

Identification pane 704 also includes a representation of the extent that the software asset has been normalized. In this example, each of the relevant identification parameters associated with the software asset type was successfully normalized during discovery, and so the normalization status is “Normalized”. Examples illustrating scenarios where some or all of such identification parameters were not normalized are described below in relation to FIGS. 7B, 7C, and 7D.

Additional information pane 706 may include indications of a product type, platform, language, edition, and full version. The product type may indicate whether the program is “Licensable” or “Not licensable”. The platform may specify, for example, a type of operating system on which the discovered software program type is installed.

The GUI may be displayed on a client device disposed within the managed network or elsewhere. The remote network management platform may include one or more server devices that provide a web-based representation of the GUI to the client device. In some examples, the GUI may be part of a software program installed within the managed network, such as on the client device itself, or on the proxy servers.

FIG. 7B depicts an example GUI 700 that displays a partially normalized configuration item associated with a particular software program type. As described above in relation to FIG. 7A, FIG. 7B includes selection pane 701, and software discovery model page 702, which is selectable from selection pane 701, and which includes identification pane 704 and additional information pane 706.

As noted above in relation to FIG. 6A, certain identification parameters included in a configuration item might not be normalized. In such scenarios, these portions might not be provided for display on the GUI. Further, identification pane 704 may indicate, in the representation of the software program type, that the particular software program type is only partially normalized. In the present example, the version has been left blank. However, such information may be manually entered via the client device. In the present example, a cursor is displayed on identification pane 704 in the “Version” data entry field to indicate that data is about to be entered into the field.

Once the input is entered into the data entry field to complete each of the fields, the normalization status may change to “manually entered”, as depicted in FIG. 7C. Such manually entered information may be used to supplement data stored in a normalization database, such as normalization database 610 so that, during future discovery phases associated with the particular software program type (or even related software program types, such as software programs sharing a publisher name with the particular software program type), the information can be normalized.

FIG. 7D depicts an example GUI that displays a non-normalized configuration item associated with a particular software program type. As described above in relation to FIG. 7A, FIG. 7D includes selection pane 701, and software discovery model page 702, which is selectable from selection pane 701, and which includes identification pane 704 and additional information pane 706. However, in the present example, each field on identification pane 704 is blank.

In this case, none of the relevant identification parameters associated with the configuration item were normalized. In such scenarios, the information may be manually entered into all of the data entry fields, and the normalization database may be updated based on the input.

As noted above, where the remote management network platform manages more than one managed network, client devices associated with the managed networks may each supply such information to an individual normalization database via a software discovery model page, such as software discovery model page 702. For example, as depicted above in relation to FIG. 6A, each normalization database may be included within a separate customer instance, such as customer instance 322. Therefore, to provide comprehensive normalization data to each such normalization database, a centralized database within remote network management platform 320 may be configured to receive updates from each normalization database associated with a separate customer instance, and to provide comprehensive sets of normalization data to each normalization database. In this way, for example, normalization database 610 included within customer instance 322 may receive updated normalization data from normalization databases associated with customer instances 324, 326, and 328.

In other examples, the normalization database may not be contained within a particular customer instance, such that each customer instance updates the same normalization database. Accordingly, information supplied by a first managed network to the normalization database via the GUI may benefit a second managed network and vice versa.

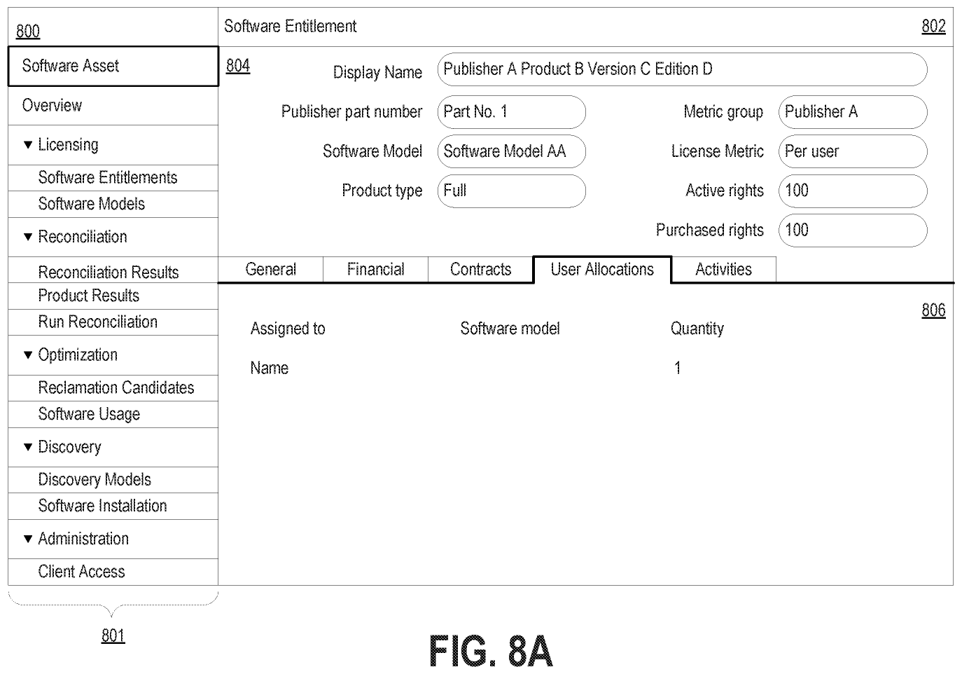

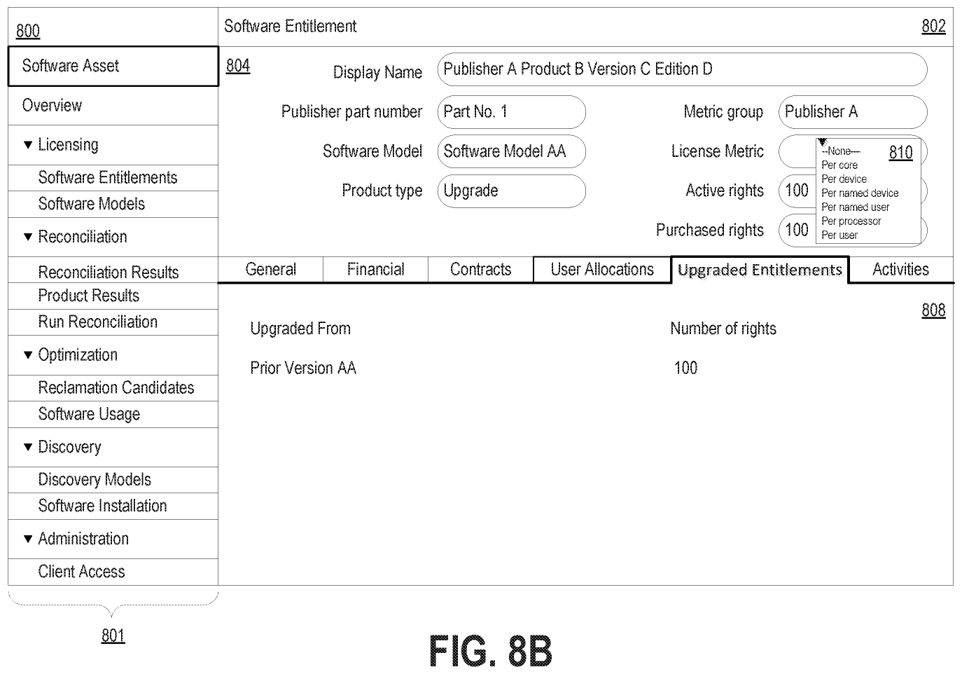

FIG. 8A depicts an example GUI 800 that displays a software program entitlement page 802 associated with a particular software program type. GUI 800 includes selection pane 801, and software entitlement page 802 may be selectable therefrom. Software entitlement page 802 includes an identification pane 804 and a selectable user allocations pane 806.

Software program entitlement page 802 may be used by a user of a client device. The input thereto may specify software license rights held by a managed network. In some embodiments, such input may be manually entered into data entry fields of software entitlement page 802. In other embodiments, such input may be derived from a software license file that contains details of the licensed software programs, and the number of licenses held by the managed network. Entitlement page 802 may also specify to which software program type such software license rights correspond. The information input to data entry fields corresponding to identification pane 804 may be stored by one or more server devices disposed in a remote network management platform on one or more databased disposed in the platform. Such stored information may be used to determine what software program license rights are held by a managed network.

In the present example, identification pane 804 includes data entry fields representative of the software type, such as a publisher part number, “Part No. 1”, and software model, “Software Model AA”. The data entry fields may also be representative of a product type, “Full”, of the associated software program.

In general, the product type may be “full”, or an “upgrade”. Where the product type is “full”, the implication is that an entirely new software program has been licensed such that the license rights are held by the managed network. Where the product type is an “upgrade”, the implication is that an existing software program has been updated. Further, the user allocations pane 806 may include inputs representative of a named user or device to which a software program is assigned, a software model indicative of the software type that has been assigned, such as “Software Model AA”, and a quantity of licenses associated with the user or device to which the software program is assigned. In some scenarios, such as when the software program type is licensed on a per core basis, the quantity of installs allotted to a single user or device may be greater than one. However, in other scenarios, such as where the software program type is assigned on a per user basis, the quantity assigned to a single user or device may be one.

Identification pane 804 additionally includes representations of a metric group, license metric, active rights, and purchased rights. Such information is indicative of how the number of licenses held by the managed network is counted, how many rights the managed network already holds, and how many additional license rights have been purchased. In the present example, the metric group is associated with a particular publisher, “Publisher A”. The particular publisher may have a predefined set of license metric types, as described below in relation to FIG. 8B. The license metric “Per user” indicated that software installations associated with Part No. 1 and Software Model AA are to be counted on a per user basis. The managed network holds 100 active rights, as a result of purchasing the 100 purchased rights.

FIG. 8B depicts another example GUI 800 that displays software program entitlement page 802 associated with the same software program type as that of FIG. 8A. GUI 800 includes selection pane 801 from which software entitlement page 802 is selectable. In the present example, software entitlement page 802 includes identification pane 804 and selectable upgraded entitlements pane 808. While any or all of the data entry fields displayed may be filled by manual input from a client device, in the present example only the license metric is displayed as being manually filled.

As described above, the license metric may specify how compliance with a software program license right is determined. In the present example, the license metric data entry field includes a drop down menu 810. In some examples, the drop down menu may correspond to a metric group associated with a particular publisher. In the present example, drop down menu 810 displays a set of license metric types associated with Publisher A. However, in other examples, no metric group may be input, and the license metric may include any number of ways of determining compliance with the software program. In the present example, drop down menu 810 includes determinations per core, per device, per named device, per named user, per processor, and per user.

Identification pane 804 may further include indications of a number of active rights, “100”, and purchased rights, “100”, associated with the software program type. The number of active rights is representative of the total number of licenses held by the managed network, while number purchased rights is indicative of the number of licenses most recently purchased. In the present example, the number of active rights is identical to the number of purchased rights. However, in examples where the managed network already holds software license rights when the additional software license rights are purchased, the number of active rights exceeds the number of purchased rights.

In the present example, the product type is an “upgrade” of a previous version or edition. Where the product type specifies that the software program license rights being purchased are an “upgrade”, the software entitlement page 802 may include selectable upgraded entitlements pane 808. Upgraded entitlements pane 808 may include representations of which version or edition the purchased software program is being upgraded, “Prior Version AA”, and a number of rights in the upgrade that are being purchased, “100”.

When a vendor sells license rights in an upgrade, the license rights in the prior version may expire. As such, including this information may allow the remote network management platform to determine compliance with the new license terms. In particular, the platform may be able to determine that 100 software license rights were previously held for “Prior Version AA”, and that the managed network currently holds 100 active rights in “Software Model AA”. The platform may determine that certain users or devices have failed to uninstall the prior version, and thus have failed to comply with the updated license terms.

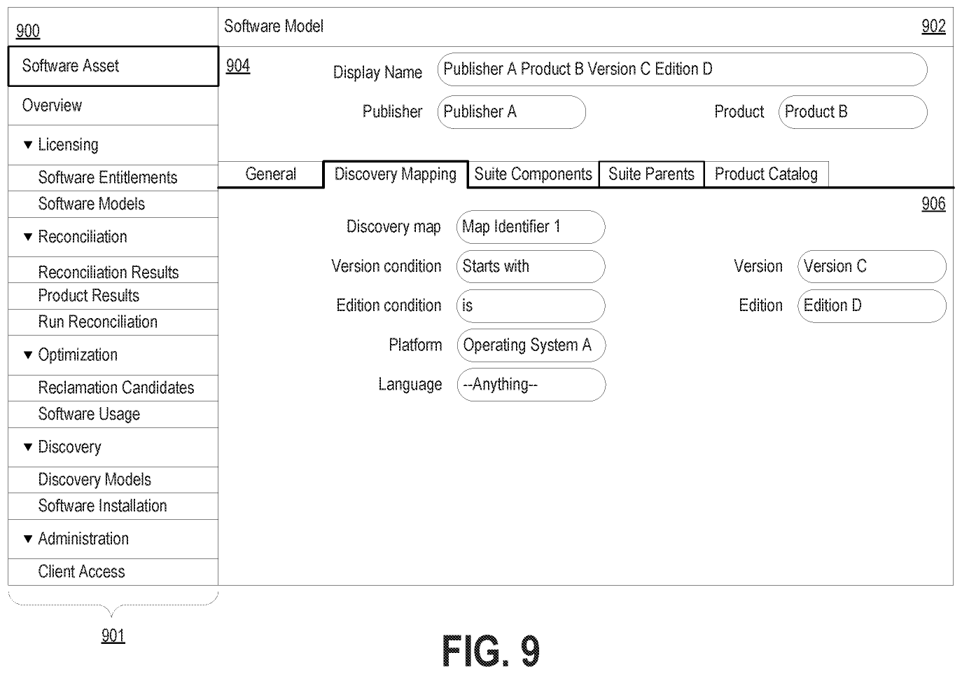

FIG. 9 depicts an example GUI 900 that displays software model page 902, which specifies conditions for mapping a particular software program type to corresponding software program license rights. Software model page 902 may be selectable from selection pane 901 included within GUI 900, and includes identification pane 904. Identification pane 904 includes representations of the particular software program type to be mapped. Particularly, identification pane 904 includes representations of a publisher, “Publisher A”, and a product, “Product B”. Software model page 902 also includes a selectable discovery mapping pane 906 that includes data entry fields representative of a discovery map (“Map identifier 1”), version condition (“Starts with”), edition condition (“is”), platform (“Operating System A”), and language (“Anything”) associated with both the particular software program type and particular representations of license rights held by the managed network.

The discovery map “Map Identifier 1” may refer to a set of data that associates the particular software type specified in identification pane 904 with the set of software entitlements described in FIGS. 8A or 8B. In other words, the map identifier may refer to a data structure or structures that map a type of software installed within the managed network to a type of software license rights held by the managed network. Such mapping may associate publishers and or products such as “Publisher A” or “Product B”. However, more targeted mapping is possible as well. In the present example, such mapping is further delimited by a version condition and an edition condition, though further delimiters are possible as well.

The version condition may be chosen from a group that includes “Starts with”, “is”, “contains”, or other search delimiters. In the present example, the version condition is specified as “Starts with Version C”, meaning that the discovery map associated with “Map Identifier 1” is limited to mapping to software types including Version C or later versions. Similarly, such mapping is limited to a software type that “is Edition D”. It should be understood that several discovery maps may encompass the same installed software or licenses. For example, a discovery map may include all licenses for a particular publisher. However, in other examples, such as the present example, a more targeted discovery map may include a particular product, version, and/or edition.

Additionally, separate discovery maps may exist for a first version of a software program type and a second version. The second version may be an upgrade purchased as described above in relation to FIG. 8B. So, the discovery map for the first version may allow the one or more server devices to associate a representation of zero license rights with several existing installs that should be terminated, while the discovery map for the second version may allow the one or more server devices to associate representations of several license rights with some existing installs.

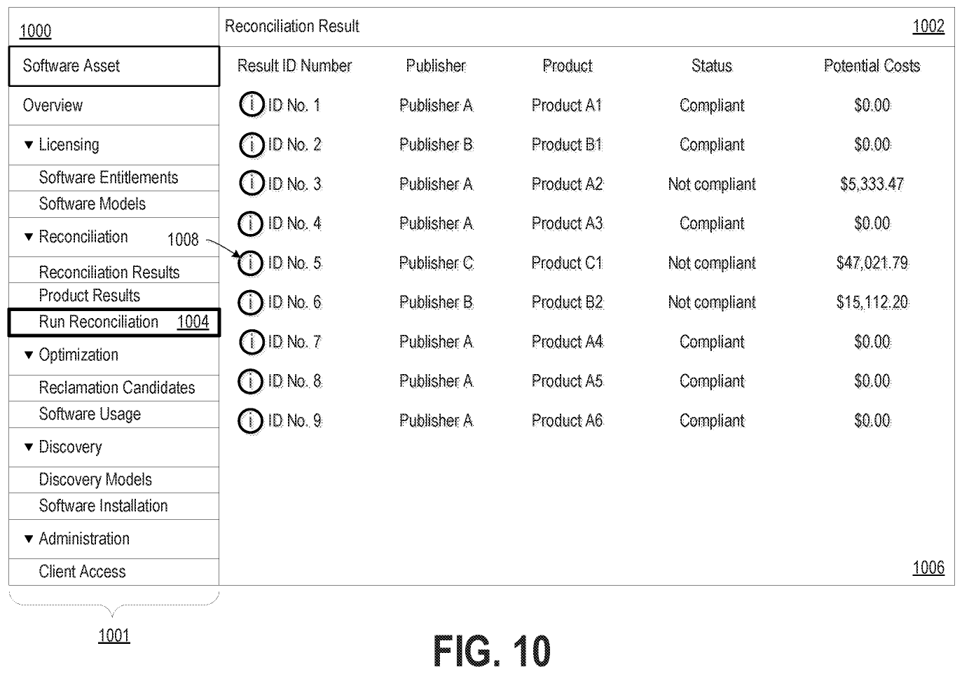

FIG. 10 depicts an example GUI that displays a reconciliation result page. The GUI 1000 may include selection pane 1001. Selection pane 1001 may include representations of several pages to select from. Included in the selection pane 1001 are a software entitlements page, a software models page, a reconciliation results page, a run reconciliation page, and other options. Selecting the run reconciliation page option 1004 may prompt input from the client device to specify for which software program types to run the reconciliation. The inputs may include specific discovery map identifiers featured in FIG. 9. However, selecting run reconciliation page option 1004 may additionally, or alternatively, allow a user to run reconciliation on any and all software program types discovered within the managed network. Further, while a user may select run reconciliation page option 1004 to run reconciliation, such reconciliation may occur periodically. For instance, the remote network management platform may automatically run reconciliation on all discovery software program types once a day, once a week, or over some other timeframe.

The one or more server devices associated with a customer instance may determine, based on stored discovery maps associated with the inputs, whether software programs associated with the discovery maps are compliant with license rights held by the managed network. The one or more server devices may then provide for display on the client device a representation of a GUI that denotes whether the software programs are compliant with associated license rights held by the managed network.

Reconciliation result page 1002 may include a compliance indication pane 1006. Compliance indication pane 1006 includes indications of result ID numbers, software program publishers, software program products, compliance statuses, and costs associated with over-licensing or under-licensing. A different result ID number may be associated with each software program type for which reconciliation was run. In the present example, reconciliation was run for nine particular software program types corresponding to ID Numbers 1 through 9. Of these, software program types associated with ID numbers 1, 2, 4, 7, 8, and 9 are denoted as being “compliant”, meaning that, for each such software program type, the number of license rights associated with the listed software program publisher and product is greater than the number of installations associated with the listed software publisher and product.

The reconciliation page further comprises selectable software model result option 1008 for each result ID number. Upon receiving the an input associated with selection of a software model result option, the one or more server devices are configured to provide for display by the client device, a representation of a GUI that includes further details and options relevant to the associated software program type.

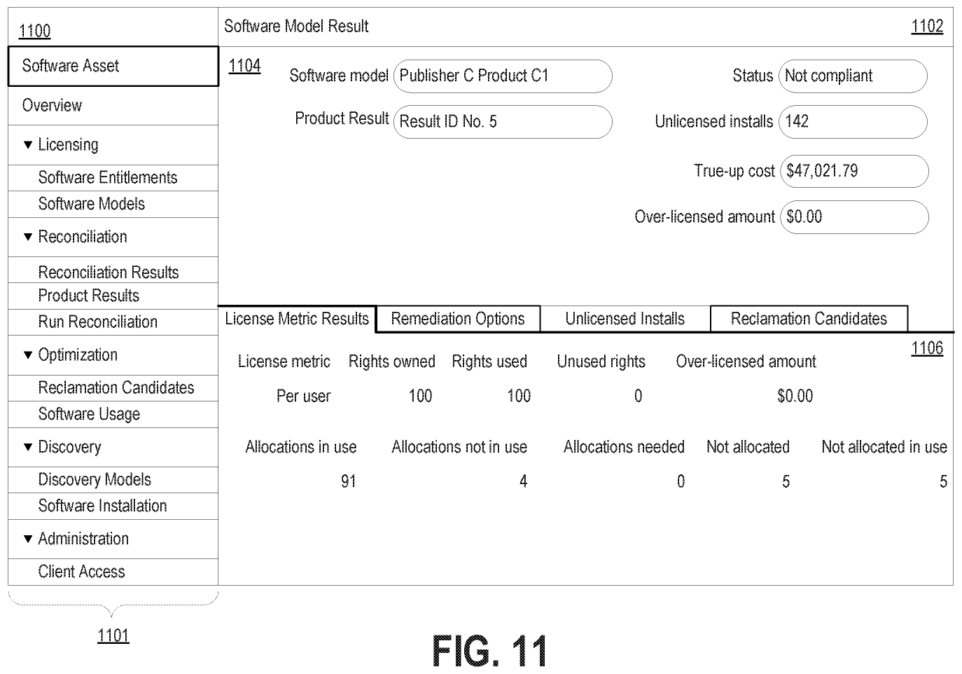

FIG. 11 depicts an example GUI 1100 that displays software model result page 1102 associated with reconciliation result page 1002. Software model result page 1102 includes identification pane 1104 and selectable license metric results pane 1106.

Identification pane 1104 includes indications of the software model “Publisher A Product B Edition D” and a product result identifier “Result ID No. 5”. Identification pane 1104 additionally provides indications of a reconciliation status “Not compliant”, number of unlicensed rights, “142”, amount of true-up cost to cover additional licenses, “$47,021.79”, and an over-licensed amount “$0.00”.

License metric results pane 1106 may include further details of an associated reconciliation result discussed above in relation to FIG. 10. In the present example, pane 1106 includes indications of the license metric (“Per user”), license rights owned (“100”), license rights used (“100”), unused license rights (“0”), over-licensed amount (“$0.00”), software program allocations in use (“91”), software program allocations not in use (“4”), software program allocations needed (“0”), software programs that were not allocated (“5”), and software programs that were not allocated but are in use, i.e. software programs that were installed without permission (“5”).

This data may allow an enterprise to evaluate whether to purchase additional license rights, license less software programs, or uninstall software programs from certain devices. In particular, the indication of software program allocations that are not in use indicates software license rights that are being used inefficiently. In the present example, license metric results pane 1106 indicates that five users were allocated software license rights, but have not used the software program associated with those rights. Such users may be candidates for reclamation of those software license rights. That is, the rights may be allocated to different users instead.

In the present example, identification pane 1104 includes indications of unlicensed installs and true-up cost. These indicate how many installations of the software program type are unlicensed, and how much the enterprise owes to remediate the unlicensed installs.

Selectable license metric results pane 1106 is selectable from among a remediation options pane, an unlicensed installs pane, and a reclamations candidates pane. The remediation options pane may specify a number of additional license rights required to place the managed network in compliance with its license rights, the unlicensed installs may specify users or devices that have unlicensed installs, and the reclamation candidates may specify users or devices that are not using the software program, and so should uninstall the software.

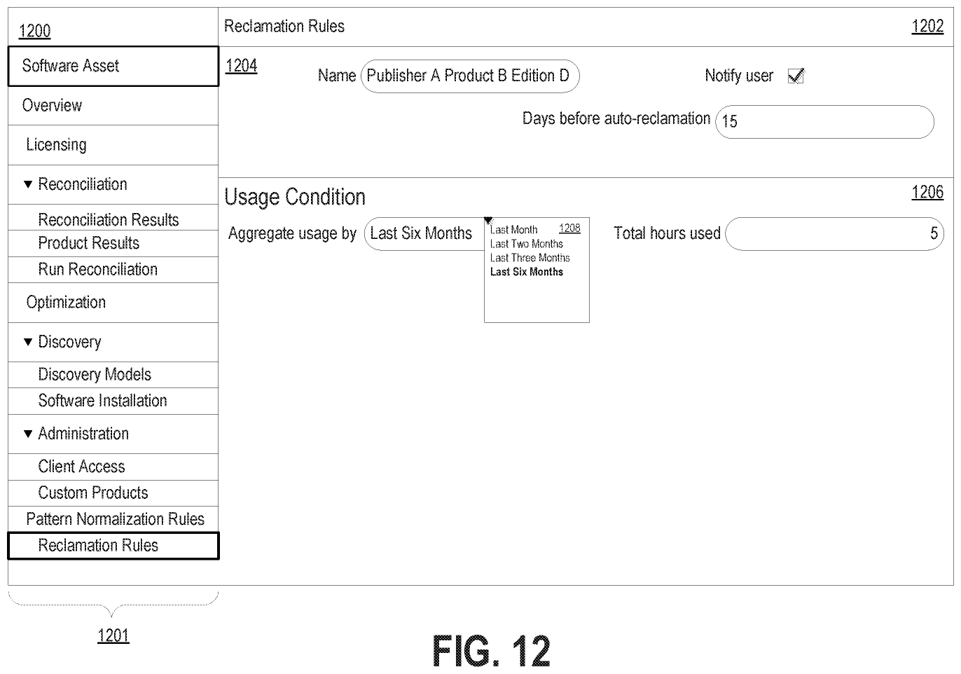

FIG. 12 depicts an example GUI 1200 that displays reclamation rules page 1202. Reclamation rules page 1202 specifies rules associated with a specific software program type to determine whether it should be reclaimed from a user or device. That is, whether the particular software program should be uninstalled from a particular computing device, processor, core, etc.

Reclamation rules page 1202 includes an identification pane 1204 that specifies an application software type, “Publisher A Product B Edition D”, an option to notify a user before reclamation, and a number of days prior to reclamation to notify the user of the impending reclamation (“15”). Such a notification may give a user time to determine whether the software program is essential, or can be uninstalled. Reclamation rules page 1202 further includes usage condition pane 1206 that includes an aggregate usage timeframe and a total hours of usage threshold. If a user or device does not meet or exceed the total hours of usage threshold within the aggregate usage timeframe, the user or device will be considered a reclamation candidate. In the present example, the aggregate usage timeframe of “Last Six Months” is selected from drop down menu 1208, which includes a six month, three month, two month, and one month timeframe, though other timeframes are possible as well. The specified total hours used is “5”. Thus, a user or device that does not use the program specified in identification pane 1204 for five or more hours within a six month timeframe will be deemed to be a reclamation candidate.

Determining such usage of various software programs may be performed by a usage tracking application associated with a computing device on which the particular software program is installed. The usage tracking application may determine how much time the computing device spends using the software program. Further, the application may send indications of the software usage to the customer instance.

The one or more server devices disposed within the customer instance may be configured to receive, from the client device, input in one or more data entry fields associated with the identification pane or the usage condition pane. Responsive to receiving the input, the server devices may retrieve relevant usage data from the usage tracking application to determine the amount of usage associated with the software programs installed on each computing device. The server devices may also determine, based on the retrieved usage data, whether the amount of usage associated with any of the software programs installed on the computing devices does not meet the hours of usage threshold.

The one or more server devices may also compile and store a list of software programs installed on the computing devices that do not meet the threshold. This way, in some embodiments, the one or more servers can automatically, by way of the proxy servers, reclaim the software programs by uninstalling the software programs on the list. In other embodiments, the one or more server devices can provide, for display by a client device a representation of such users or computing devices on a reclamation candidates page selectable from selection pane of the GUI. The representations may include an uninstall option and, upon selection of an uninstall option, the one or more server devices may be configured to, by way of the proxy servers, cause a computing device to uninstall the software program.

In general, the process of reconciliation may include three phases. During discovery, one or more server devices disposed within a remote network management platform may cause proxy servers associated with a managed network to probe computing devices within the managed network to retrieve configuration items therefrom. The probing may be subject to certain criteria, such as by license metrics specified by the one or more server devices. The one or more server devices may store representations of software programs discovered by the probing in one or more databases, and may normalize the stored representations. During entitlement, the one or more server devices may receive input from a client device associated with the managed network indicative of license rights held by the managed network that are associated with software programs. Finally, during reconciliation, the one or more server devices may determine, based on discovery maps that associate software program installations with software program license rights held by the managed network, whether the managed network is in compliance with the license rights. The one or more server devices may provide for display a representation of a GUI that indicates whether the managed network is in compliance with the software program license rights. Additionally, the GUI may provide options to purchase new license rights or to uninstall software programs from certain computing devices based on lack of use of the software programs on those computing devices.

### VIII. EXAMPLE OPERATIONS

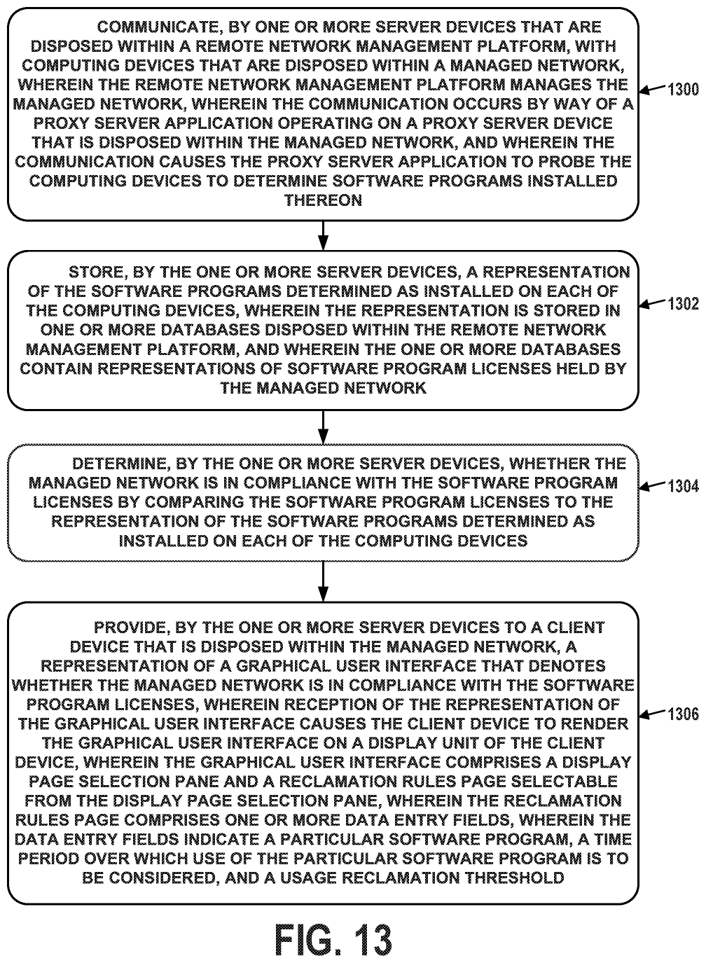

FIG. 13 is a flow chart illustrating an example embodiment. The process illustrated by FIG. 13 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device.

The embodiments of FIG. 13 may be simplified by the removal of any one or more of the features shown therein. Further, these embodiments may be combined with features, aspects, and/or implementations of any of the previous figures or otherwise described herein.

A. Discovery/Entitlement

Block 1300 may be carried out to communicate, by one or more server devices that are disposed within a remote network management platform, with computing devices that are disposed within a managed network. The one or more server devices, may, for example, be disposed within customer instance 322, and perform the functions described above in relation to FIGS. 5A and 6A. The remote network management platform may manage the managed network. For example, the remote network management platform 322 may perform the functions described above in relation to FIGS. 3, 5A, and 5B. In the present example, the one or more server devices may communicate with the computing devices by way of a proxy server application operating on a proxy server device that is disposed within the managed network, such as proxy servers 312. The communication may cause the proxy server application to probe the computing devices to determine software programs installed thereon. Such communication and probing may occur substantially as described above in relation to FIGS. 5A and 5B.

B. Storing Representations of Discovered Software Programs

Block 1302 of the process may be carried out to store, by the one or more server devices, a representation of the software programs determined as installed on each of the computing devices. Such representations may take the form of the identification parameters included in the configuration items described above in relation to FIGS. 5A and 5B. Additionally, the representation may be stored on the CMDB 500 described above in relation to FIGS. 5A and 5B. However, in other examples, the representation may be stored in one or more different databases disposed within the remote network management platform. The one or more databases may contain representations of software program licenses held by the managed network, as described above in relation to FIGS. 8, 9, and 10. Such representations of software license rights and software programs determined as installed on each of the computing devices may be included within the same one or more databases, or stored on separate databases.

C. Reconciliation

Block 1304 may be carried out by the one or more server devices to determine whether the managed network is in compliance with the software licenses to the representation of the software programs determined as installed on each of the computing devices. This determination may be based on a comparison of the software program licenses to the representation of the software programs determined as installed on each of the computing devices.

In some embodiments, the one or more databases may contain normalization data representative of a plurality of software programs. Such normalization data may include identification parameters of the software programs, such as publisher names, product names, version names, or edition names of the software programs. The normalization data may be representative of a plurality of managed networks, such as managed network 300 described throughout the detailed description. The one or more software devices may update the representation of the software programs determined as installed on each of the computing devices to conform to the normalization data. Updating the representation in this way may be performed as described above in relation to FIGS. 6A and 6B. The one or more server devices may update the representation prior to comparing the software program licenses to the representation.

In some embodiments, the one or more server devices may be further configured to receive input from one or more data entry fields of the graphical user interface that modifies the normalization data. The one or more server devices may update the normalization data based on the input in the manner described above in relation to FIGS. 7B, 7C, and 7D.

D. Display Graphical User Interface

Block 1306 may be carried out to provide, by the one or more server devices to a client device such as the computing devices described in FIG. 5A and 6A, a representation of a GUI that denotes whether the managed network is in compliance with the software program licenses. Such a representation may take the form of the reconciliation result page 1002 described above in relation to FIG. 10. Reception of the representation may cause the client device to render the GUI on a display unit of the client device.

The GUI may include a display page that includes a display page selection pane, such as that described above in relation to FIGS. 7A-12. The GUI may also include a software discovery model page selectable from the display page selection pane, such as that described above in relation to FIGS. 7A-7D. The software discovery model page may indicate software program types that are installed on the computing devices. The GUI may further include a software entitlement page selectable from the display page selection pane, such as that described above in relation to FIGS. 8A and 8B. The software entitlement page may indicate the software program licenses held by the managed network. The GUI may additionally include a reconciliation result page, such as that described above in relation to FIG. 10. The reconciliation result page may indicate whether the managed network is in compliance with the software program licenses.

In some embodiments, the one or more server devices may be further configured to receive, from the client device, input from one or more data entry fields of the software discovery model page. The data entry fields may represent a publisher name, product name, version name, or edition name. The one or more server devices may probe the computing devices for software programs installed thereon that match the input.

In some embodiments, the one or more server devices may be configured to receive, from the client device, input from one or more data entry fields of the software entitlement page. The input may relate to a particular software program license held by the managed network, and represent a publisher name, product name, version name, or edition name related to the particular software program license. The input may also include a license metric entry field that specifies how compliance with the particular software program license is determined. In some embodiments, the license metric entry field may specify that compliance with the particular software program license is determined on a per processor basis, per processor core basis, per device basis, per named device basis, per user basis, or per named user basis. The one or more server devices may update the representations of the software program licenses based on the input.

In some embodiments, the reconciliation page may further include a selectable software model result option, such as that described in relation to FIG. 10. The one or more server devices may be configured to receive, from the client device, selection of the software model result option. The one or more server devices may be further configured to provide, by way of the GUI a software model result page, such as that described above in relation to FIG. 11. The software model result page may include a selectable license metric results pane indicative of the software program licenses and the software programs installed within the managed network, and a selectable remediation options pane indicative of a number of additional software program licenses needed to comply with the software program licenses.

In some embodiments, the selectable license metric results pane may include a license metric indicative of how the number of additional software program licenses needed to comply with the software program licenses was determined.

In some embodiments, the selectable reconciliation options pane may include a selectable remediation option. The one or more server devices are further configured to receive, from the client device, an indication that the selectable remediation option has been selected. The one or more server devices may also be configured to provide, to the client device by way of the graphical user interface, a purchase order display page. The purchase order display page comprises a plurality of data entry fields indicating a software program publisher, a type of software program license for purchase, a number of software program licenses for purchase, and a license metric that specifies how compliance with the purchased software program licenses is determined. The one or more server devices may further be configured to receive, from the client device, input from the one or more data entry fields. The one or more server devices may be additionally configured to, responsive to receiving the input, place an order related to the data entry fields.

In some embodiments the GUI may include a display page selection pane and a reclamation rules page selectable from the display page selection pane, such as that described above in relation to FIG. 12. The reclamation rules page may include one or more data entry fields. The data entry fields may indicate a particular software program, a time period over which use of the particular software program is to be considered, and a usage reclamation threshold.

In some embodiments, the one or more server devices may be configured to receive, from the client device, input from the one or more data entry fields of the reclamation rules page. The one or more server devices may also be configured to, based on the received input, retrieve usage data associated with each of the computing devices. The retrieved data may indicate, over the time period, amounts of usage associated with the software programs determined as installed on each of the computing devices.

In some embodiments, the one or more server devices may be further configured to determine a list of software programs with usages that do not meet the usage reclamation threshold.

The one or more server devices may additionally be configured to instruct the proxy server to uninstall the software programs on the list. Reception of the instruction may cause the proxy server to remotely access at least some of the computing devices to uninstall the software programs on the list.

In other embodiments, the list may be stored in the one or more databased disposed within the remote network management platform. In these embodiments, the GUI may further include a reclamation candidates page selectable from the selection pane. The reclamation candidates page may include a representation of at least part of the list and uninstall options corresponding to software programs in the list. The one or more server devices may be further configured to receive, from the client device, selection of a particular uninstall option from the uninstall options. The one or more server devices may also be configured to instruct the proxy server to uninstall a particular software program associated with the particular uninstall option. Reception of the instruction may cause the proxy server to remotely access at least some of the computing devices to uninstall the particular software program.

In some embodiments, the one or more databases may contain a list of software program types installed within the managed network. The one or more server devices may be configured to, for each program software type on the list, repeatedly communicate with the computing devices to determine software programs of that software program type installed thereon. The one or more server devices may also be configured to store a representation of the software programs of that type determined as installed on each of the computing devices. The one or more server devices may further be configured to determine whether the managed network is in compliance with software program licenses associated with that software program type. The one or more server devices may be additionally configured to store a representation of the determination as to whether the managed network is complaint with the software program licenses associated with that software program type.

In such embodiments, the one or more server devices may be configured to receive, from the client device, input in one or more data entry fields of the GUI. The input may be representative of a publisher name or product name that identifies the software program type. The graphical user interface denoting whether the managed network is in compliance with the software program licenses may comprise the graphical user interface denoting whether the managed network is complaint with the software program licenses associated with the identified software program type.

E. Other Variations and Embodiments

The systems and methods described above may be carried out by any number of components within an aPaaS system that manages one or more managed networks. As such, it should be understood that the steps described above in relation to FIG. 13 may be carried out other ways than those explicitly disclosed. Accordingly, a system may include means for determining software programs installed on computing devices disposed within a managed network. Further, the system may include means for determining software licenses held by the managed network. The system may also, include means for determining whether the managed network is in compliance with the software license rights. Additionally, the system may include means for displaying the determination as to whether the managed network is in compliance with the software license rights.

### IX. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
one or more server devices disposed within a remote network management platform, wherein the one or more server devices comprise one or more hardware processors and at least one non-transitory memory storing:
one or more databases containing representations of software program licenses held by a managed network, and wherein the remote network management platform is configured to manage the managed network; and
instructions that, when executed by the one or more hardware processors, cause the one or more hardware processors to perform operations comprising:
receiving, from computing devices disposed within the managed network, indications of a plurality of software installations thereon,
storing, in the one or more databases, a representation of the plurality of software installations on each of the computing devices,
determining, by comparing the representations of the software program licenses to the representation of the plurality of software installations on each of the computing devices, whether the managed network is in compliance with the software program licenses,
providing, to a client device disposed within the managed network, a representation of a graphical user interface that denotes whether the managed network is in compliance with the software program licenses, wherein reception of the representation of the graphical user interface causes the client device to render the graphical user interface on a display unit of the client device, wherein the graphical user interface comprises one or more data entry fields configured to enable identification of a particular software program, a time period over which use of the particular software program is to be considered, and a usage reclamation threshold, and wherein the usage reclamation threshold corresponds to a minimum amount of usage of a particular software installation of the particular software program over the time period,
receiving, from the client device, input from the one or more data entry fields of the graphical user interface,
identifying one or more software installations of the plurality of software installations that do not meet the usage reclamation threshold, and
transmitting instructions to uninstall the one or more software installations of the plurality of software installations that do not meet the usage reclamation threshold.

2. The system of claim 1, wherein the one or more databases contain normalization data representative of a plurality of software programs, wherein the normalization data includes publisher names, product names, version names, or edition names of the plurality of software programs, and wherein the operations comprise:
prior to comparing the representations of the software program licenses to the representation of the plurality of software installations on each of the computing devices, updating the representation of the plurality of software installations on each of the computing devices to conform to the normalization data.

3. The system of claim 2, wherein the operations comprise:
receiving, from the client device, input from the one or more data entry fields of the graphical user interface, wherein the input modifies the normalization data; and
updating the normalization data based on the input.

4. The system of claim 3, wherein the plurality of software programs are associated with a plurality of managed networks, and wherein the managed network is one of the plurality of managed networks.

5. The system of claim 3, wherein the one or more databases comprise a normalization database associated with the managed network, wherein the normalization database has stored thereon at least a portion of the normalization data, wherein the normalization database is configured to receive additional updated normalization data from a centralized database disposed within the remote network management platform, and wherein the centralized database is configured to receive the additional updated normalization data from one or more client devices associated with one or more additional managed networks configured to be managed by the remote network management platform.

6. The system of claim 3, wherein the one or more databases comprise a normalization database associated with a plurality of managed networks, wherein the managed network is one of the plurality of managed networks, wherein the normalization database has stored thereon at least a portion of the normalization data, and wherein the normalization database is configured to receive additional updated normalization data from one or more client devices associated with one or more additional managed networks of the plurality of managed networks.

7. The system of claim 1, wherein the graphical user interface comprises a plurality of display pages selectable from a selection pane, wherein the plurality of display pages comprise a software discovery model page that indicates software program types that are installed on the computing devices, a software entitlement page that indicates the software program licenses, and a reconciliation result page that indicates whether the managed network is in compliance with the software program licenses.

8. The system of claim 7, wherein the operations comprise:
receiving, from the client device, input from one or more additional data entry fields of the software discovery model page, wherein the input represents a publisher name, product name, version name, or edition name; and
probing the computing devices for software installations installed thereon that match the input from the one or more additional data entry fields.

9. The system of claim 7, wherein the operations comprise:
receiving, from the client device, input from one or more additional data entry fields of the software entitlement page, wherein the input from the one or more additional data entry fields relates to a particular software program license held by the managed network, wherein the input from the one or more additional data entry fields represents a publisher name, product name, version name, or edition name related to the particular software program license, and wherein the input also includes a license metric entry field that specifies how compliance with the particular software program license is determined; and
updating the representations of the software program licenses based on the input from the one or more additional data entry fields.

10. The system of claim 9, wherein the license metric entry field specifies that compliance with the particular software program license is determined on a per processor basis, per processor core basis, per device basis, per named device basis, per user basis, or per named user basis.

11. The system of claim 7, wherein the reconciliation result page comprises a selectable software model result option, and wherein the operations comprise:
receiving, from the client device, selection of the selectable software model result option; and
providing, to the client device by way of the graphical user interface, a software model result page, wherein the software model result page comprises a selectable license metric results pane indicative of the software program licenses and the plurality of software installations installed within the managed network, and a selectable remediation options pane indicative of a number of additional software program licenses needed to comply with the software program licenses.

12. The system of claim 11, wherein the selectable license metric results pane includes a license metric indicative of how the number of additional software program licenses needed to comply with the software program licenses was determined.

13. The system of claim 11, wherein the selectable remediation options pane includes a selectable remediation option, and wherein the operations comprise:
receiving, from the client device, an indication that the selectable remediation option has been selected;
providing, to the client device by way of the graphical user interface, a purchase order display page, wherein the purchase order display page comprises a plurality of data entry fields indicating a software program publisher, a type of software program license for purchase, a number of software program licenses for purchase, and a license metric that specifies how compliance with the software program licenses for purchase is determined;
receiving, from the client device, input from the plurality of data entry fields; and
responsive to receiving the input, placing an order related to the data entry fields.

14. The system of claim 1, comprising a proxy server, wherein the instructions are transmitted to the proxy server, and wherein reception of the instructions causes the proxy server to remotely access at least some of the computing devices to uninstall the one or more software installations.

15. The system of claim 1, wherein the operations comprise:
storing a list of the one or more software installations in the one or more databases.

16. The system of claim 15, wherein the graphical user interface comprises a reclamation candidates page, wherein the reclamation candidates page includes a representation of at least part of the list and uninstall options corresponding to the one or more software installations in the list, wherein the operations comprise:
receiving, from the client device, selection of a particular uninstall option from the uninstall options; and
providing instructions to uninstall the particular software installation associated with the particular uninstall option.

17. The system of claim 1, wherein the one or more databases contain a list of software program types installed within the managed network, and wherein the operations comprise:
for each software program type on the list, repeatedly receiving from the computing devices indications of software installations of that software program type installed thereon;
storing a representation of the software installations of that software program type installed on each of the computing devices;
determining whether the managed network is in compliance with software program licenses associated with that software program type;
storing a representation of the determination as to whether the managed network is compliant with the software program licenses associated with that software program type; and
receiving, from the client device, input in one or more additional data entry fields of the graphical user interface, wherein the input is representative of a publisher name or product name that identifies the software program type, and wherein the graphical user interface denoting whether the managed network is in compliance with the software program licenses comprises the graphical user interface denoting whether the managed network is compliant with the software program licenses associated with the software program type.

18. The system of claim 1, wherein the instructions to uninstall the one or more software installations of the plurality of software installations cause the computing devices to automatically uninstall the one or more software installations.

19. A method comprising:
receiving, by one or more server devices disposed within a remote network management platform, from computing devices disposed within a managed network a plurality of software installations thereon, wherein the remote network management platform is configured to manage the managed network;
storing, by the one or more server devices, a representation of the plurality of software installations on each of the computing devices, wherein the representation is stored in one or more databases disposed within the remote network management platform, and wherein the one or more databases contain representations of software program licenses held by the managed network;
determining, by the one or more server devices, whether the managed network is in compliance with the software program licenses by comparing the representations of the software program licenses to the representation of the plurality of software installations on each of the computing devices;
providing, by the one or more server devices to a client device disposed within the managed network, a representation of a graphical user interface that denotes whether the managed network is in compliance with the software program licenses, wherein reception of the representation of the graphical user interface causes the client device to render the graphical user interface on a display unit of the client device, wherein the graphical user interface comprises one or more data entry fields configured to enable identification of a particular software program, a time period over which use of the particular software program is to be considered, and a usage reclamation threshold, and wherein the usage reclamation threshold corresponds to a minimum amount of usage of a particular software installation of the particular software program over the time period;
receiving, by the one or more server devices from the client device, input from the one or more data entry fields of the graphical user interface;
identifying, by the one or more server devices, one or more software installations of the plurality of software installations that do not meet the usage reclamation threshold; and
transmitting, by the one or more server devices, instructions to uninstall the one or more software installations of the plurality of software installations that do not meet the usage reclamation threshold.

20. The method of claim 19, wherein the minimum amount of usage comprises a non-zero amount usage.

21. The method of claim 19, wherein the graphical user interface comprises a plurality of display pages selectable from a selection pane, wherein the plurality of display pages comprise a software discovery model page that indicates software program types that are installed on the computing devices, a software entitlement page that indicates the software program licenses, and a reconciliation result page that indicates whether the managed network is in compliance with the software program licenses.

22. The method of claim 21, comprising:
receiving, from the client device, input from one or more additional data entry fields of the software entitlement page, wherein the input from the one or more additional data entry fields relates to a particular software program license held by the managed network, wherein the input from the one or more additional data entry fields represents a publisher name, product name, version name, or edition name related to the particular software program license, and wherein the input also includes a license metric entry field that specifies how compliance with the particular software program license is determined; and
updating the representations of the software program licenses based on the input from the one or more additional data entry fields.

23. At least one non-transitory computer-readable medium, having stored thereon program instructions that, upon execution by one or more processors, cause the one or more processors to perform operations comprising:
receiving from computing devices disposed within a managed network a plurality of software installations stored thereon, wherein a remote network management platform is configured to manage the managed network;
storing a representation of the plurality of software installations on each of the computing devices, wherein the representation is stored in one or more databases disposed within the remote network management platform, and wherein the one or more databases contain representations of software program licenses held by the managed network;
determining whether the managed network is in compliance with the software program licenses by comparing the representations of the software program licenses to the representation of the plurality of software installations on each of the computing devices;
providing, to a client device that is disposed within the managed network, a representation of a graphical user interface that denotes whether the managed network is in compliance with the software program licenses, wherein reception of the representation of the graphical user interface causes the client device to render the graphical user interface on a display unit of the client device, wherein the graphical user interface comprises one or more data entry fields configured to enable identification of a particular software program, a time period over which use of the particular software program is to be considered, and a usage reclamation threshold, and wherein the usage reclamation threshold corresponds to a minimum amount of usage of the particular software program over the time period;
receiving, from the client device, input from the one or more data entry fields of the graphical user interface;
identifying one or more software installations of the plurality of software installations that do not meet the usage reclamation threshold; and
transmitting instructions to uninstall the one or more software installations of the plurality of software installations that do not meet the usage reclamation threshold.

24. The at least one non-transitory computer-readable medium of claim 23, wherein the graphical user interface comprises a plurality of display pages selectable from a selection pane, wherein the plurality of display pages comprise a software discovery model page that indicates software program types that are installed on the computing devices, a software entitlement page that indicates the software program licenses, and a reconciliation result page that indicates whether the managed network is in compliance with the software program licenses.

25. The at least one non-transitory computer-readable medium of claim 24, wherein the operations comprise:
receiving, from the client device, selection of a selectable software model result option of the software discovery model page; and
providing, to the client device by way of the graphical user interface, a software model result page, wherein the software model result page comprises a selectable license metric results pane indicative of the software program licenses and the plurality of software installations installed within the managed network, and a selectable remediation options pane indicative of a number of additional software program licenses needed to comply with the software program licenses.

26. The at least one non-transitory computer-readable medium of claim 25, wherein the operations comprise:
receiving, from the client device, an indication that a selectable remediation option of the selectable remediation options pane has been selected;
providing, to the client device by way of the graphical user interface, a purchase order display page, wherein the purchase order display page comprises a plurality of data entry fields indicating a software program publisher, a type of software program license for purchase, a number of software program licenses for purchase, and a license metric that specifies how compliance with the software program licenses for purchase is determined;
receiving, from the client device, input from the plurality of data entry fields; and
responsive to receiving the input, placing an order related to the data entry fields.
